(19) United States
(12) Patent Application Publication
(10) Pub. No.: US 2016/0347041 A1
(43) Pub. Date: Dec. 1, 2016

(54) Oil and water absorbent food packing material, method for manufacturing the same and tray using the same

(71) Applicant: CJ Cheiljedang Corporation, Seoul (KR)

(72) Inventors: Eun Jin Park, Seoul (KR); Sung Joo Lee, Gyeonggi-do (KR); Dong Hui Park, Daejeon (KR)

(21) Appl. No.: 15/165,922

(22) Filed: May 26, 2016

(30) Foreign Application Priority Data
May 29, 2015 (KR) 10-2015-0076683

(51) Int. Cl. B32B 27/08; B32B 38/00; B32B 38/04; B65D 81/26; B32B 27/32; B32B 5/02; B32B 27/12; B32B 37/15; B32B 27/36

(52) U.S. Cl. CPC B32B 27/08; B32B 37/153; B32B 38/0008; B32B 38/0032; B32B 38/04; B32B 27/36; B32B 27/32; B32B 5/02; B32B 27/12; B65D 81/264; B32B 2307/726; B32B 2439/70; B32B 2250/02; B32B 2250/24; B32B 2367/00; B32B 2323/00; B32B 2305/026

(57) ABSTRACT

The present invention relates to an oil and water absorbent food packing material, a method for manufacturing the same, and a tray using the same, and more particularly, to an oil and water absorbent food packing material that is obtained by bonding a porous layer and a substrate layer through extrusion lamination, to a method for manufacturing a porous food packing material by means of extrusion lamination of a porous layer and a substrate layer, and to a tray manufactured by molding the food packing material so that it can absorb oil and water generated from a frozen food to be cookable in a microwave oven.

### RELATED APPLICATION

This application claims priority to Korean Application Serial No. 10-2015-0076683, filed May 29, 2015, the content of which is incorporated here by reference in its entirety.

### BACKGROUND OF THE INVENTION

Field of the Invention

The present invention relates to an oil and water absorbent food packing material, a method for manufacturing the same, and a tray using the same, and more particularly, to an oil and water absorbent food packing material that is obtained by bonding a porous layer and a substrate layer through extrusion lamination, thus allowing oil and water to be all absorbent thereto, a method for manufacturing the same, and a tray using the same.

Background of the Related Art

Oil absorbent paper, which is generally on sale on the market, is manufactured by coating silicon Si or polyethylene PE onto a sheet of paper, and otherwise, the oil absorbent paper itself is provided with an oil absorbent capability. As a result, the oil absorbent paper has a function of absorbing oil thereto.

In case of instant foods, such oil absorbent paper can absorb oil from the instant foods, but in case of frozen processed foods which are fried and frozen, oil and water are mixedly generated when cooked in a microwave oven, so that after the cooking, a lot of oil and water remains on the food packing material, thus undesirably making the food packed by the food packing material wet and weakening the durability of the food packing material. That is, the existing packing material has silicon or polyethylene coated onto the surface thereof, so that there are no pores on the surface of the packing material, and further, surface tension exists according to the features of the plastic material, thus undesirably making oil and water remain on the surface of the packing material, without having any absorption to the packing material.

In case of microwave cooked foods, further, they generally use trays made of polypropylene PP, but oil or water are not absorbed to the plastic material itself. Accordingly, when the fried and frozen processed foods are cooked in the microwave oven, the oil and water generated from the foods make the foods undesirably wet.

On the other hand, a method for manufacturing an oil and water absorbent packing material is conducted by means of dry lamination or extrusion lamination.

The dry lamination includes the steps of coating an adhesive solution dissolved in an aqueous or organic solvent onto the surface of a first base material like a plastic film or aluminum foil, evaporating and drying the solvent by means of hot air or heating to form an adhesive layer, pressurizingly bonding a second base material to the adhesive layer by means of polymerizing lamination, and winding the bonded materials to finish curing the adhesive layer.

The packing material manufactured through the dry lamination has the most excellent performance in the interlayer adhesive force through appropriate selection of the base materials and the adhesive and in a variety of resistances required for post processing thereof. Accordingly, almost all of the packing materials used for sterilizing and packing retort foods are made by means of the dry lamination. However, if the dry lamination is applied to a method for manufacturing a packing material made by laminating a food contacted porous film or fabric and a plastic sheet on top of each other, foreign odor may be generated from the adhesive, thus undesirably lowering the preference of the product.

On the other hand, the extrusion lamination includes the steps of extruding a melted resin to a shape of a film from a slit die, coating the melted resin film onto a base material, supplying another base material from an unwinder, and bonding the base materials to each other at the same time.

Through the extrusion lamination, the melted resin is extruded to the shape of the film from the slit die and coated onto the base material, without having any step of drying the adhesive, and next, another base material is supplied from the unwinder, bonded to the coated base material, and cooled, so that the extrusion lamination has a lower possibility in the generation of the foreign odor than the dry lamination.

Further, there has been proposed Korean Patent No. 10-0892760 disclosing an absorbent tray and a method for manufacturing the same. More particularly, the conventional absorbent tray has a structure of open cells made by adding, foaming and molding an antistatic agent to a polystyrene material, and in post process, a plurality of absorbent holes is formed on the inner bottom surface of the tray in such a manner as to communicate with the open cells, thus allowing a liquid like blood and water generated from foods, such as meat and fish, packed on the tray to be absorbed to the open cells through the absorbent holes.

However, the tray using the polystyrene material has a low heat resistance temperature, and accordingly, it may be deformed dangerously when cooked at a high temperature. At this time, unfortunately, environmental hormone may be emitted from the tray using the polystyrene material. Therefore, the tray using the polystyrene material is not adequate for a packing material used for frozen processed foods to be cooked in hot water or a microwave oven.

Accordingly, the packing materials should be differently used in accordance with properties, purposes and shapes of the contents packed therewith, and therefore, there is a need to provide an optimal material in accordance with the features of the packing materials.

Therefore, there is a need for the development of a novel packing material capable of effectively absorbing oil and water generated when a frozen process food requiring microwave cooking is cooked.

So as to obtain a packing material capable of effectively absorbing both of oil and water, accordingly, the inventors have had many studies so that they find an oil and water absorbent food packing material made by bonding a porous film or a fabric made of polyolefin and a plastic sheet by means of extrusion lamination, thus finally making the food packing material effectively absorbing oil and water generated when a frozen process food requiring microwave cooking is cooked.

### SUMMARY OF THE INVENTION

Accordingly, the present invention has been made in view of the above-mentioned problems occurring in the prior art, and it is an object of the present invention to provide an oil and water absorbent food packing material, a method for manufacturing the same, and a tray using the same.

To accomplish the above-mentioned object, according to a first aspect of the present invention, there is provided an oil and water absorbent food packing material including: a porous layer; and a substrate layer disposed on the underside of the porous layer.

To accomplish the above-mentioned object, according to a second aspect of the present invention, there is provided a method for manufacturing an oil and water absorbent food packing material including the step of bonding a porous layer and a substrate layer to each other by means of extrusion lamination.

To accomplish the above-mentioned object, according to a third aspect of the present invention, there is provided an oil and water absorbent tray manufactured with the oil and water absorbent food packing material.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIGS. 1A and 1B are side sectional views showing an oil and water absorbent food packing material having a porous layer and a substrate layer according to the present invention, wherein FIG. 1A shows the porous layer made of a porous film having pores formed on the top surface thereof and FIG. 1B shows the porous layer made of a non-woven fabric;

FIG. 2 is a perspective view showing the oil and water absorbent food packing material according to the present invention;

FIG. 3 is a schematic view showing an apparatus for manufacturing the oil and water absorbent food packing material according to the present invention through a first manufacturing example;

FIG. 4 is a schematic view showing a tray manufactured using the oil and water absorbent food packing material according to the present invention through a second manufacturing example;

FIG. 5 is a photograph showing a conventional polypropylene tray A and a tray B made using the food packing material according to the present invention through a first experiment example;

FIGS. 6A, 6B, and 6C are photographs showing the first experiment example results of the conventional polypropylene tray A and the tray B made using the food packing material according to the present invention, wherein FIG. 6A shows the states of croquettes on the trays before cooking in an microwave oven, FIG. 6B shows those after cooking in the microwave oven (with 1000 W for two minutes), and FIG. 6C shows the oil and water absorbed to the trays and those still remaining on the croquettes after the cooking; and

FIGS. 7A and 7B are photographs showing the results of a conventional paper tray C, the conventional polypropylene tray A, and the tray B made using the food packing material according to the present invention, through a second experiment example, wherein FIG. 7A shows their plane view and FIG. 7B shows their perspective views.

### DETAILED DESCRIPTION OF THE PREFERRED EMBODIMENTS

Hereinafter, an explanation on an oil and water absorbent food packing material according to the present invention will be in detail given with reference to the attached drawing.

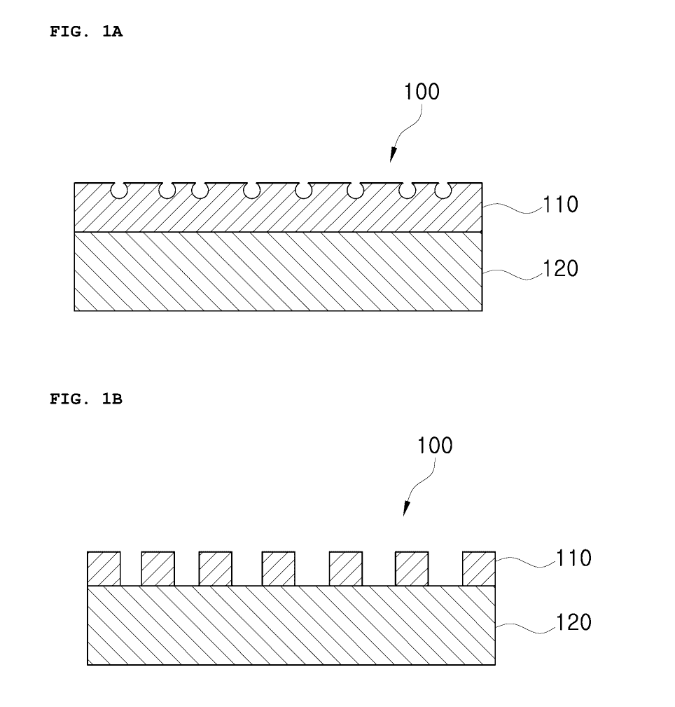

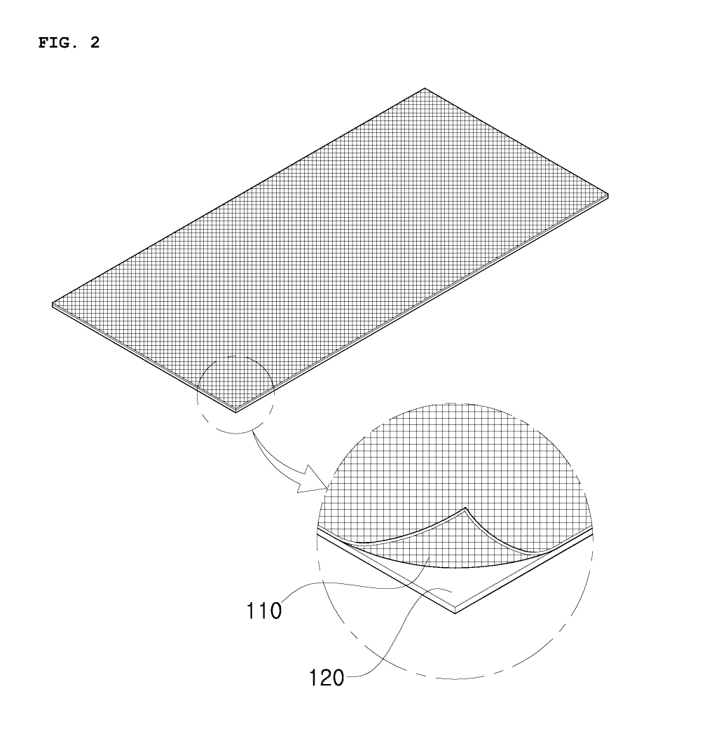

FIGS. 1A and 1B are side sectional views showing an oil and water absorbent food packing material according to the present invention, wherein the oil and water absorbent food packing material 100 has a porous layer 110 and a substrate layer 120, and FIG. 2 is a perspective view showing the oil and water absorbent food packing material according to the present invention.

According to a first aspect of the present invention, there is provided the oil and water absorbent food packing material 100 including the porous layer 110 and the substrate layer 120.

According to the present invention, the porous layer 110 serves to effectively absorb the oil and water generated while a frozen processed food is being cooked in a microwave oven.

The porous layer 110 is any one selected from a porous film and a fabric. Of course, the porous layer 110 is not limited to the above-mentioned materials, but may be made of other materials only if they can provide the same effects to a person of ordinary skill in the art.

The porous film is made of any one selected from polyester and polyolefin PO, and desirably, the porous film is made of polypropylene PP having a substantially high melting point, a relatively low manufacturing cost, and no environmental hormone emitted therefrom, so that it can be used as a tray. Further, the porous film is processed by means of embossing, laser, pinpoint, or chemical treatment.

Furthermore, the fabric is a woven fabric or a non-woven fabric, which is made of any one selected from polyester and polyolefin PO, and desirably, the fabric is made of polypropylene PP having a substantially high melting point, a relatively low manufacturing cost, and no environmental hormone emitted therefrom, so that it can be used as a tray. In the same manner as the porous film, further, the fabric is processed by means of embossing, laser, pinpoint, or chemical treatment.

Desirably, the non-woven fabric is used as the porous layer 110, which provides excellent effects in view of the manufacturing cost and the oil and water absorbing capability.

FIG. 1A shows the porous layer 110 made of the porous film having pores formed on the top surface thereof and FIG. 1B shows the porous layer 110 made of the non-woven fabric.

The pores formed on the porous layer 110 desirably have sizes in the range of 2 to 10 μm. If the sizes of the pores are more than 10 μm, delamination occurs when water or oil enters the pores, and contrarily, if the sizes of the pores are less than 2 μm, oil or water molecules do not pass through the pores so that oil and water are not absorbed at all.

The porous layer 110 has a thickness in the range of 0.3 to 0.8 mm, desirably in the range of 0.4 to 0.7 mm. If the thickness of the porous layer 110 is less than 0.3 mm, the porous layer 110 is broken or split upon molding of a tray because it has a low thickness, and contrarily, if the thickness of the porous layer 110 is more than 0.8 mm, the porous layer 110 is torn upon molding of a tray because it has a high thickness. Due to the high thickness of the porous layer 110, further, the manufacturing cost may be raised.

According to the present invention, the substrate layer 120 serves to support the underside of the porous layer 110 thereagainst and to mold the food packing material to a shape of a tray having bottom and lateral surfaces.

The substrate layer 120 has a shape of a sheet made of any one selected from polyester and polyolefin PO, and desirably, the substrate layer 120 is made of a polypropylene PP having a substantially high melting point, a relatively low manufacturing cost, and no environmental hormone emitted therefrom, so that it can be used as a tray. Accordingly, the substrate layer 120 is desirably made of a polypropylene sheet having a sufficient elongation percentage so that it can be molded to the tray.

On the other hand, the substrate layer 120 is desirably made of the same material as the porous layer 110. For example, if the substrate layer 120 and the porous layer 110 are made of PET-PET or PO-PO as the same materials as each other, they can be bonded to each other by means of heat sealing when they are laminated on top of each other. The heat sealing is conducted in the range of the melting point of the porous layer 110, desirably in the range of 150 to 200° C., more desirably in the range of 170 to 190° C.

The substrate layer 120 has a thickness in the range of 0.2 to 0.8 mm, desirably in the range of 0.3 to 0.5 mm. If the thickness of the substrate layer 120 is less than 0.2 mm, it is hard to have a fixed shape as a tray because the substrate layer 120 has a low thickness, and contrarily, if the thickness of the substrate layer 120 is more than 0.8 mm, the manufacturing cost may be raised.

According to a second aspect of the present invention, there is provided a method for manufacturing an oil and water absorbent food packing material, the method including the step of bonding the porous layer 110 and the substrate layer 120 to each other by means of extrusion lamination.

If the porous layer and the substrate layer are bonded to each other by means of dry lamination generally used when a food packing material is manufactured in the conventional practice, foreign odor may be generated from an adhesive used, thus lowering the preference of the product. According to the present invention, therefore, the food packing material is manufactured through extrusion lamination wherein no adhesive or solvent is used.

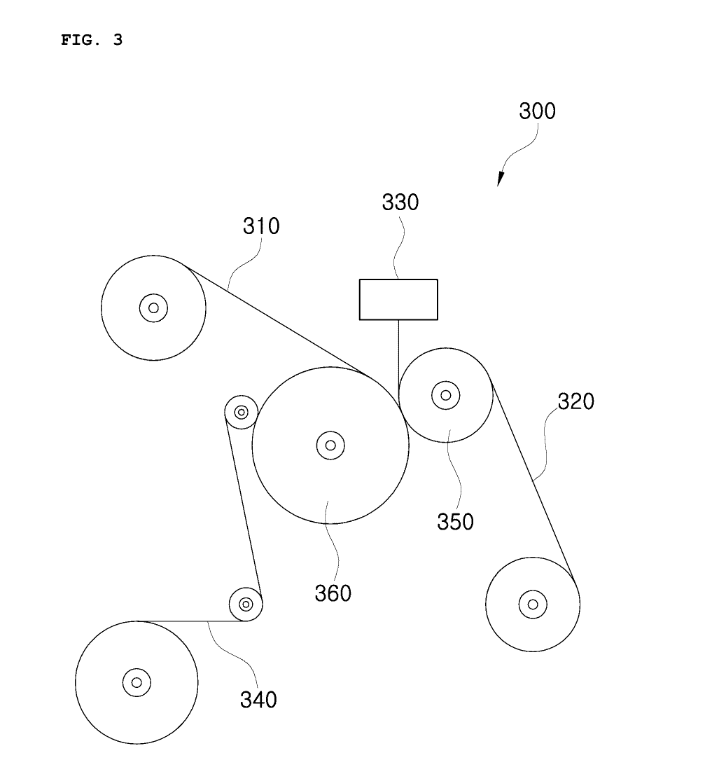

The extrusion lamination occurs when a melted resin extruded to a shape of a film from a slit die 330 is coated onto the porous layer 110 and the substrate layer 120 unwound from respective unwinders and next, the porous layer 110 and the substrate layer 120 are bonded to each other. Desirably, bonding of the porous layer 110, the melted resin, and the substrate layer 120 occurs at the same time (See FIG. 3).

The porous layer 110 is any one selected from a porous film and a fabric. Of course, the porous layer 110 is not limited to the above-mentioned materials, but may be made of other materials only if they provide the same effects to a person of ordinary skill in the art.

The porous film is made of any one selected from polyester and polyolefin PO, and desirably, the porous film is made of polypropylene PP having a substantially high melting point, a relatively low manufacturing cost, and no environmental hormone emitted therefrom, so that it can be used as a tray. Further, the porous film is processed by means of embossing, laser, pinpoint or chemical treatment.

Furthermore, the fabric is a woven fabric or a non-woven fabric, which is made of any one selected from polyester and polyolefin PO, and desirably, the fabric is made of polypropylene PP having a substantially high melting point, a relatively low manufacturing cost, and no environmental hormone emitted therefrom, so that it can be used as a tray. In the same manner as the porous film, further, the fabric is processed by means of embossing, laser, pinpoint or chemical treatment.

The pores formed on the porous layer 110 desirably have sizes in the range of 2 to 10 μm. If the sizes of the pores are more than 10 μm, delamination occurs when water or oil enters the pores, and contrarily, if the sizes of the pores are less than 2 μm, oil or water molecules do not pass through the pores so that oil and water are not absorbed at all.

Desirably, the non-woven fabric is used as the porous layer 110, which provides excellent effects in view of the manufacturing cost and the oil and water-absorbing capability.

The substrate layer 120 has a shape of a sheet made of any one selected from polyester and polyolefin PO, and desirably, the substrate layer 120 is made of a sheet of polypropylene PP having a substantially high melting point, a relatively low manufacturing cost, and no environmental hormone emitted therefrom, so that it can be used as a tray.

Desirably, the substrate layer 120 is desirably made of the same material as the porous layer 110. For example, if the substrate layer 120 and the porous layer 110 are made of PET-PET or PO-PO as the same materials as each other, they can be bonded to each other by means of heat sealing when they are laminated on top of each other, without having any melted resin extruded to the shape of the film from the slit die 330. The heat sealing is conducted in the range of the melting point of the porous layer 110, desirably in the range of 150 to 200° C., more desirably in the range of 170 to 190° C.

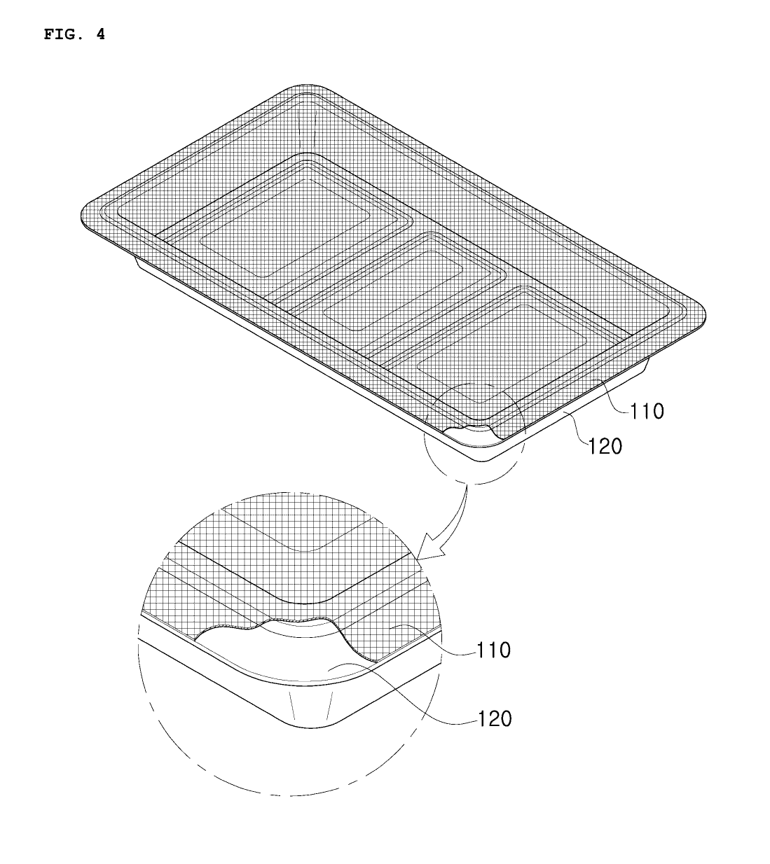

According to a third aspect of the present invention, there is provided a tray B manufactured using the oil and water absorbent food packing material (See FIG. 4).

According to the present invention, the tray B is manufactured by molding the food packing material made through the manufacturing method according to the present invention with a molding frame having a given shape by means of high pressure vacuum or thermoforming, so that it has a structure of a receptacle with a bottom surface and lateral surfaces. The depth of the tray B may be restrictedly determined upon the elongation percentage of the porous layer 110.

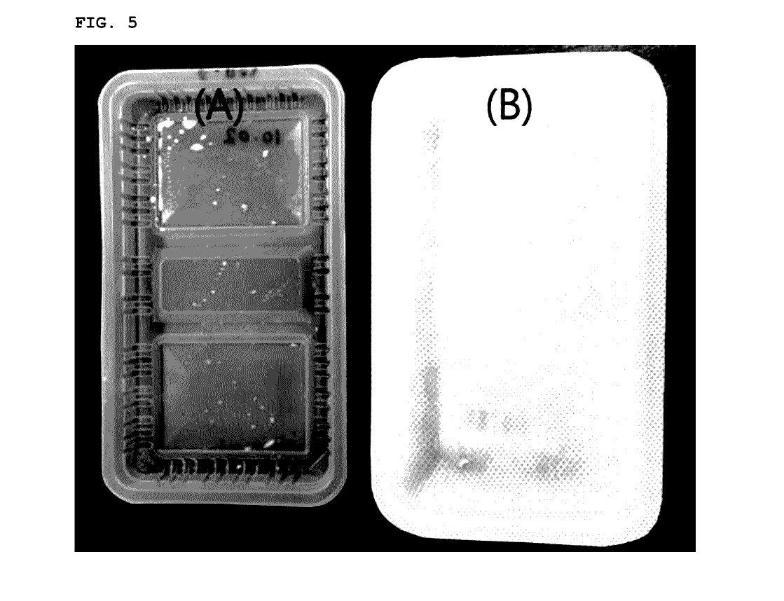

According to the present invention, desirably, the tray B, which is manufactured using the food packing material 100 having the porous layer 110 made of the non-woven fabric, has more excellent effects in the oil and water absorbing capability than a conventional tray A manufactured using only polypropylene PP (See FIGS. 5 to 7).

Hereinafter, the present invention will be in detail explained with reference to various embodiments. The various embodiments are just exemplary to help the present invention more understood, and therefore, the present invention is not limited thereto.

### EMBODIMENTS

### First Manufacturing Example

### Manufacturing the Food Packing Material

The oil and water absorbent food packing material according to the present invention was manufactured with a polypropylene substrate layer (a product, B310 of Lotte Chemical) and a polypropylene non-woven fabric (a product, SFR-171H of Lotte Chemical) through extrusion lamination wherein heat was applied at a temperature in the range of 170 to 190° C.

### Second Manufacturing Example

### Manufacturing the Tray Using the Food Packing Material

The oil and water absorbent food packing material manufactured according to the first manufacturing example was subjected to thermoforming through a pressure forming machine (VFK-1000 of VF Korea corp.) under the conditions of a molding temperature of 180 to 210° C., a mold temperature of 60 to 80° C., and a plug temperature of 130 to 160° C., thus manufacturing an oil and water absorbent tray.

### First Experiment Example

### Experiment of Oil and Water Absorption of the Tray of the Present Invention

The amounts of oil and water absorbed to the conventional polypropylene tray (PP 0.5 mm of Woojin Placom Inc.) and the tray of the present invention manufactured through the second manufacturing example were compared with each other through an experiment.

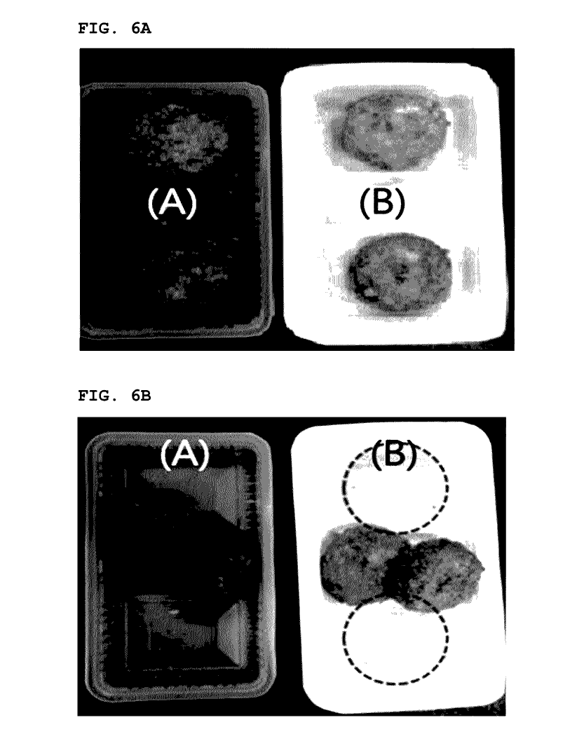

Frozen croquettes purchased in the market (fresh product croquettes of E-mart) were cooked in a microwave oven (with 1000 W) for two minutes, and next, the amounts of oil and water absorbed to the conventional polypropylene tray and the tray of the present invention were compared to each other. The comparison results are indicated in Table 1 and FIGS. 5 to 6C.

TABLE 1

| | Polypropylene | Tray of the present |
|---|---|---|
| Kinds | (PP) tray | invention |
| Amounts of oil and | 0.06 | 0.88 |
| water absorbed (g) | | |

After cooking in the microwave oven, it could be checked that oil still remained on the conventional polypropylene tray A, but oil was absorbed to the tray B of the present invention so that the oil marks just remained thereon (See FIG. 5).

After the cooked croquettes were moved to a sheet of paper to check the oil absorbed to the sheet of paper, further, it was checked that because the conventional polypropylene tray A did not absorb oil from the croquettes (See Table 1), the croquettes cooked on the conventional polypropylene tray A contained a relatively larger amount of oil therein than those cooked on the tray B of the present invention (See FIGS. 6A to 6C).

### Second Experiment Example

### Experiment of Water Absorption of the Tray of the Present Invention

A conventional paper tray C, the conventional polypropylene tray A, and the tray B of the present invention manufactured through the second manufacturing example were compared to one another through an experiment.

Water dropped on portions of the conventional paper tray C, the conventional polypropylene tray A, and the tray B of the present invention manufactured through the second manufacturing example.

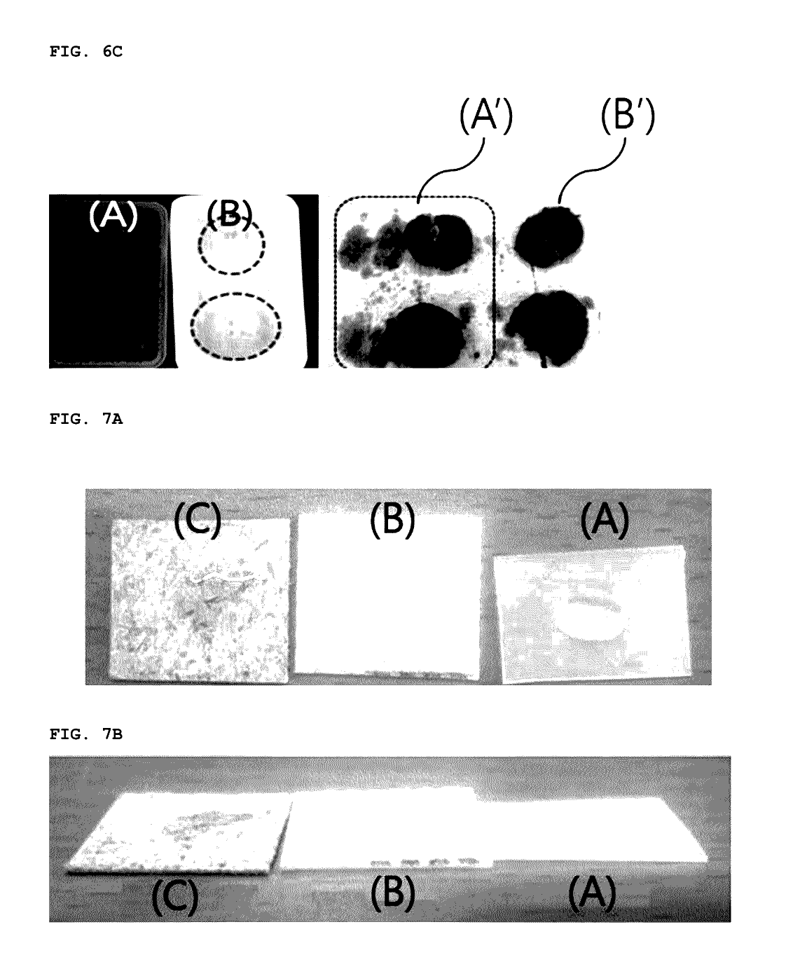

Water was a little absorbed to the conventional paper tray C, but it still remained on the surface of the tray C, so that drops of water spreaded out thereon. The conventional polypropylene tray A did not absorb water, so that water still remained on the surface of the tray A and further circular drops of water existed through the action of surface tension. In case of the oil and water absorbent tray B according to the present invention, however, it was checked that water was absorbed to the porous layer of the tray B so that no water remained on the surface of the tray B (See FIGS. 7A and 7B).

As set forth in the foregoing, the oil and water absorbent food packing material according to the present invention can effectively absorb oil and water generated when a frozen processed food is cooked, thus increasing the sizes of the markets related to fried and frozen processed foods, especially, Korean traditional foods like pan-fried foods with oil.

In addition to the fried and frozen processed foods, further, the oil and water absorbent food packing material according to the present invention can be applied to meat foods, fried foods, grilled foods, and steamed foods, from which oil and water are generated during their storage, distribution and heating processes, thus allowing the foods to be developed as instant foods and further increasing the sizes of the markets related to the processed foods.

[Explanations on Reference Numerals in the drawing]

| 100: oil and water absorbent food packing material | |
|---|---|
| 110: porous layer | 120: substrate layer |
| 300: apparatus for manufacturing oil and water | |
| absorbent food packing material | |
| 330: extrusion die | 340: oil and water absorbent |
| film | |
| 350: extrusion roll | 360: cooling roll |
| A: polypropylene tray | B: tray of the invention |

C: paper tray
A′: croquettes cooked in polypropylene tray
B′: croquettes cooked in tray of the invention

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An oil and water absorbent food packing material comprising:
a porous layer; and
a substrate layer disposed on the underside of the porous layer.

2. The oil and water absorbent food packing material according to claim 1, wherein the porous layer is any one selected from a porous film and a fabric.

3. The oil and water absorbent food packing material according to claim 1, wherein the porous layer is made of any one selected from polyester and polyolefin.

4. The oil and water absorbent food packing material according to claim 1, wherein the pores formed on the porous layer have sizes in the range of 2 to 10 μm.

5. The oil and water absorbent food packing material according to claim 1, wherein the substrate layer is made of any one selected from polyester and polyolefin.

6. The oil and water absorbent food packing material according to claim 1, wherein the substrate layer is made of the same material as the porous layer.

7. A method for manufacturing an oil and water absorbent food packing material, the method comprising the step of bonding a porous layer and a substrate layer to each other by means of extrusion lamination.

8. The method according to claim 7, wherein the pores of the porous layer are formed by means of laser processing, pinpoint processing or chemical treatment.

9. An oil and water absorbent tray manufactured by molding the oil and water absorbent food packing material according to claim 1.
